(19) United States
(12) Patent Application Publication
(10) Pub. No.: US 2004/0018322 A1
(43) Pub. Date: Jan. 29, 2004

(54) Self-contained thermal transfer label and method of preparation

(76) Inventor: Alfred Doi, Irvine, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/609,067

(22) Filed: Jun. 27, 2003

Related U.S. Application Data
(63) Continuation-in-part of application No. 09/566,341, filed on May 8, 2000, now abandoned.

(51) Int. Cl. B41J 2/01

(52) U.S. Cl. 428/32.1

(57) ABSTRACT

A self-contained thermal transfer label apparatus including a release stock supporting a release coating and, over the release coating, a first adhesive coating and a face stock. The face stock is severed into labels aligned in sequence along the face stock. An ultraviolet light curable second adhesive is disposed on portions of the upper surface of the face stock exterior to the labels. A donor ribbon strip is disposed in registry with the face stock, the donor ribbon strip providing a thermal transfer coating in engaged contact with the second adhesive and adjacent to the labels. The thermal transfer coating has a surface tension greater than a surface tension of the second adhesive so that it can be removed, taking that portion of the adhesive in contact with it. The donor ribbon strip is severed exterior to the labels enabling removal of peripheral portions of the donor ribbon strip while leaving further portions of the donor ribbon strip over the labels for later marking the labels. With the further portions of the donor strip removed, the labels may be peeled away for use.

### RELATED APPLICATIONS

This is a continuation-in-part application of a prior filed and currently pending application having Ser. No. 09/566,341 and file date of May 8, 2000.

INCORPORATION BY REFERENCE: Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to self-contained pressure sensitive thermal transfer labels and the process for making such labels.

2. Background and Description of Related Art

Thermal printing has made possible cost effective digital imaging under computer control. Thermal printing makes possible one of the most accurate methods of printing machine readable bar codes. Dots printed can be overlapped producing very distinct edges needed in bar codes.

Direct thermal printing functions to print an image directly on paper stock caged with heat sensitive chemicals. Because of the simplicity of the technology and cost effective in manufacturing, the population of the direct thermal printers in use today is numbered over three million world wide. Direct thermal images lack dimensional stability and resistance to physical and chemical reaction. The image thus made have problems in image stability, which gave rise to the introduction of thermal transfer printers. However, because of the higher costs of manufacturing, the population of direct thermal printers is greater than that of the thermal transfer printers. This invention is intended to allow direct thermal printers to produce images comparable to those produced by the more expensive thermal transfer, printers.

Thermal printing techniques can generally be segregated into two principal categories: direct thermal printing and thermal transfer printing. Direct thermal printing functions to print an image directly on the paper stock, coated with heat sensitive material. In thermal transfer printing, a thermal transfer ribbon is applied upon the paper stock before the paper stock is passed through the thermal printer. The thermal transfer ribbon, or donor ribbon generally appears similar to carbon paper, with a wax or wax-resin coating formed on the undersurface. As the paper stock/donor ribbon is passed through the thermal printer, the print head functions to melt the wax onto the underlying paper stock in prescribed patterns. The donor ribbon is then removed from the paper stock, leaving the image formed by the thermal print head.

Thermal transfer printing has advantages that make this technology attractive. In thermal transfer printing, the ink is directly applied to the paper stock, whereas with the direct thermal transfer, no ink is used. Instead, the image arises from reaction of the heat sensitive coating as the paper stock passes adjacent the thermal print head. As a result, thermal transfer printing typically can result in a higher quality printing that resists fading and allows for long-term storage and scanability. Thermal transfer printing also lends itself to color printing, allows high graphics contrast capability and provides substantial flexibility in the papers stock or other receiving media to be printed on.

Despite the foregoing advantages, there are also disadvantages associated with thermal transfer printing. Many of those disadvantages arise from the requirement that the donor ribbon, be reliably applied in flat registry with the paper stock, then removable from the paper stock after printing. Typically, the thermal transfer ribbon is wound on a separate dispensing spool and mated to the paper stock as it reaches the thermal print head. Thereafter, the used ribbon is separated from the paper stock and rewound onto a retrieval roller. Such procedures require mechanisms that are incompatible with the large population of compact thermal printers that are, currently used for many applications. Moreover, difficulties may arise in winding and rewinding the donor ribbon, wrinkling of the ribbon as it is applied to the paper, and recyclability of the donor ribbon after it is used. Disposability of the donor ribbon can be a significant problem, because many such ribbons do not readily degrade. Special treatments needed to dispose of the donor ribbon, adding cost to the labels.

In some cases, the donor ribbon is not rewound after passing through the thermal print head, but rather remains on the paper stock, and separated in use. While such techniques avoid the need for retrieving the donor ribbon, they give rise to additional difficulties resulting from adhering the donor ribbon to the paper stock. In particular, as the donor ribbon is removed from the paper stock, adhesive may remain on the paper stock causing the paper stock to be gummy, interfering with the scanability of the printed image and interfering in the ability of the paper stock to pass through dispensing mechanisms and other devices.

Accordingly, there is a need for apparatus and techniques to allow for the thermal transfer printing of labels which allows the label to be printed on conventional direct thermal printers, without the need for retrieval rollers to collect the used thermal transfer ribbon. Additionally, it is desirable that the resulting labels be cut to size as desired, with little or no adhesive remaining on the face of the label after the thermal transfer ribbon is removed.

In some cases, the donor ribbon is not rewound after passing through the thermal print head, but rather remains on the paper stock, and is separated in use. While such techniques avoid the need for retrieving the donor ribbon, they give rise to additional difficulties resulting from adhering the donor ribbon to the paper stock. In particular, as the donor ribbon is removed from the paper stock, adhesive may remain on the paper stock causing the paper stock to be gummy, interfering with the scanability of the printed image and interfering in the ability of the paper stock to pass through dispensing mechanisms and other devices. An important need is for a thermal printing ribbon that may be made up without the need for surface treatment for adjustment of surface tension to assure the selective removal of one strip from the next and location of release and adhesive layers.

Accordingly, there is a need for apparatus and techniques to allow for the thermal transfer printing of labels which allows the label to be printed on conventional direct thermal printers, without the need for retrieval rollers to collect the used thermal transfer ribbon. Additionally, it is desirable that the resulting labels be cuttable to size as desired, with little or no adhesive remaining on the label after the thermal transfer ribbon is removed.

Relevant References Include:

U.S. Pat. No. 6,309,498 to A. Doi which teaches a self-contained thermal transfer label. The product is formed as paper stock having an area of release material applied to a surface portion thereof. A layer of adhesive material is applied upon the release material. A thermal transfer donor ribbon is mated to the label by the area of adhesive material. The donor ribbon is treated, prior to mating with the label, such that the surface tension at the donor ribbon is modified to a level substantially different from that of the release material. As a consequence, when the donor ribbon is removed from the label, after printing on the label, the adhesive remains secured to the donor ribbon, rather than-the underlying label. A result is a label that may support a higher quality image, but without adhesive residue after the donor sheet is peeled away. A drawback with this transfer label and it method of manufacture is that surface treatment must be applied for adjustment of surface tension.

Imamura, et al., U.S. Pat. No. 5,427,840 describes a co-winding type thermal transfer sheet that is constituted by forming on one surface side of a substrate film a heat-fusible ink layer comprising a pigment and a particulate binder, and causing a tracing paper to be peelably bonded onto the heat-fusible ink layer by the medium of an adhesive layer. The thus constituted co-winding type thermal transfer sheet is capable of providing an original image which can be reproduced by use of a blueprint process so as to provide blueprint images having a high precision and a high contrast. In addition, a co-winding type thermal transfer sheet may also be constituted by forming a heat-fusible ink layer on one surface side of a substrate film and causing a transparent resin sheet to be peelably bonded onto the heat-fusible ink layer by the medium of an adhesive layer containing a cross-linking agent. The thus constituted co-winding type thermal transfer sheet is capable of providing an image excellent in wear resistance on the transparent resin sheet. The transparent resin sheet after the image formation may be used as an OHP (overhead projector) sheet without contaminating the sheet having no liquid absorbing property.

Mitchell, Jr., U.S. Pat. No. 5,738,748 describes a label stock including a thermal transfer facestock and a thermal transfer ribbon that are laminated together. The face stock has a front face for receiving thermal transfer ink and a back face covered by an adhesive. The ribbon has a front face covered by thermal transfer ink and a back face covered by a release. The facestock and ribbon are laminated and wound together into a roll so that the ribbon also functions as a conventional release liner.

AIM, Thermal “Transfer Printing”, AIM's ‘Thermal Transfer Printing’, 1993, pp. 1-7, AIM USA Copyright.

Anonymous Author, “UV Silicone and Emulsion Adhesive Tandem Coating”, North America, November/December 1999, pp. 44, 49.

### SUMMARY OF THE INVENTION

The present invention teaches certain benefits in construction and use which give rise to the objectives described below.

The present invention is a self-contained thermal transfer label apparatus including a release stock supporting a release coating and, over the release coating, a first adhesive coating and a face stock. The face stock is in registration with the release stock, with the lower surface of the face stock in adhesive contact with the adhesive coating. The face stock is severed into labels aligned along the face stock. An ultraviolet light curable second adhesive is disposed on portions of the upper surface of the face stock exterior to the labels. A donor ribbon strip is disposed in registry with the face stock, the donor ribbon strip providing a thermal transfer coating in engaged contact with the second adhesive. The thermal transfer coating has a surface tension greater than a surface tension of the second adhesive so that it can be removed with the adhesive attached. The donor ribbon strip is severed exterior to the labels enabling removal of portions of the donor ribbon strip while leaving further portions of the donor ribbon strip over the labels for later marking the labels. With the further portions of the donor strip removed, the labels may be peeled away for use. One aspect of the present invention concerns the ability to generate secure facsimile based communications. In some cases it is desirable that communications received by facsimile are not disclosed to personnel other than the intended recipient. Use of the present invention provides for a product and technique whereby, except for the transmission cover page, only the intended recipient will review the communication. By means of the present invention, it would be readily detectible if anyone would remove donor ribbon, which is necessary to read the communication. Accordingly, the present invention not only allows existing direct thermal printers to print higher quality documents, but also allows the documents to be communicated in a secure mode.

A primary objective of the present invention is to provide an apparatus and method of use of such apparatus that provides advantages not taught by the prior art.

Another objective is to provide such an invention capable of being more simply fabricated and used.

A further objective is to provide such an invention with a simple adhesive curing step.

A still further objective is to provide such an invention capable of enabling a high quality image transfer to a paper stock, and permitting a secure facsimile communication using the invention.

These and other advantages and features are achieved in the present invention as described below. Of particular note is my prior patent describing a similar process to that of the instant invention as described below.

### BRIEF DESCRIPTION OF THE DRAWINGS

The accompanying drawings illustrate the present invention. In such drawings:

FIG. 1 is an exploded perspective view of the preferred embodiment of the invention;

FIG. 2 is a longitudinal cross-sectional view of a pressure sensitive label stock thereof as taken along line 2-2 in FIG. 1;

FIG. 3 is a longitudinal cross-sectional view of the label stock of FIG. 2 with labels severed and an ultraviolet adhesive layer applied over the labels as taken along line 33 in FIG. 1;

FIG. 4 is a longitudinal cross-sectional view of the assembly of FIG. 3 and additionally showing a transfer layer placed over the adhesive layer as taken along line 4-4 in FIG. 1; and

FIG. 5 is a transverse cross-sectional view of the label stock of FIG. 4 as taken along line 5-5 in FIG. 1.

### DETAILED DESCRIPTION OF THE INVENTION

The above described drawing figures illustrate the invention in at least one of its preferred embodiments, which is further defined in detail in the following description.

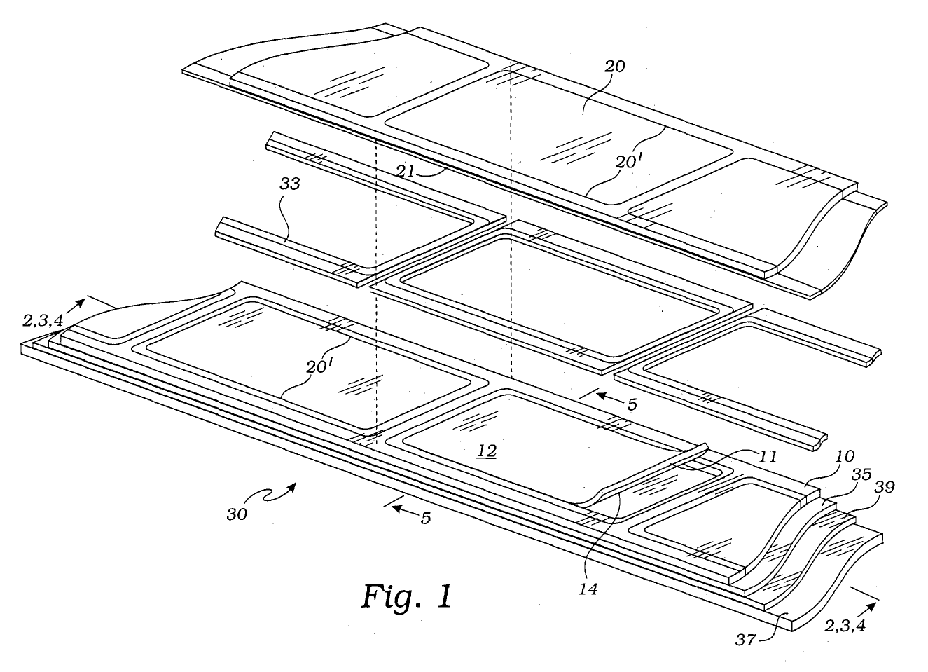

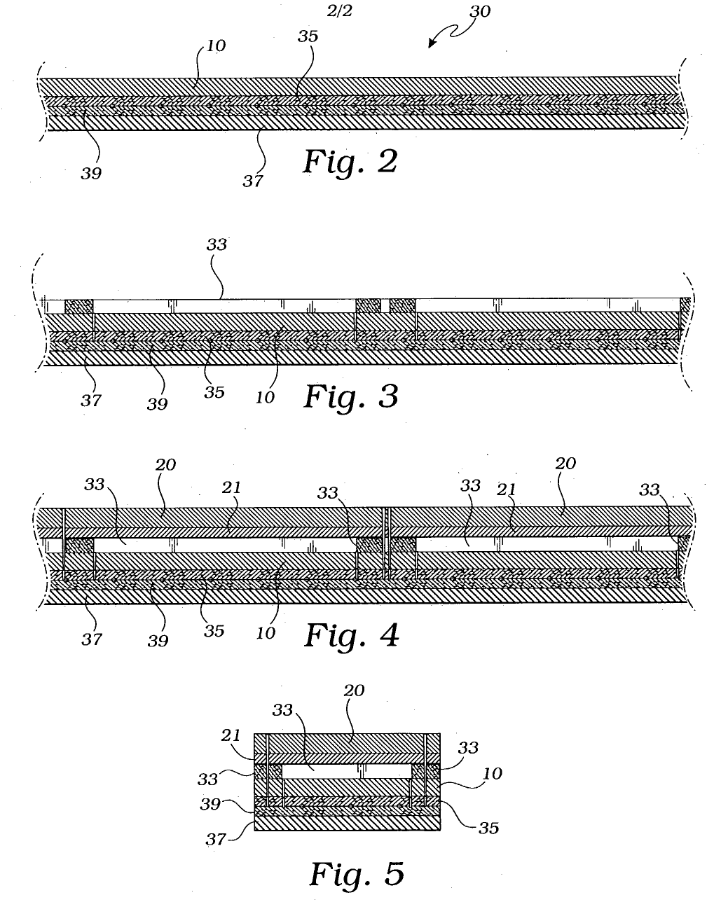

The present invention is a self-contained thermal transfer label apparatus and the method of preparing such. It comprises a release stock 37, preferably of paper or plastic, supporting a release coating 39 and, over the release coating, a first adhesive coating 35. A face stock preferably of paper or plastic 10, from which printed labels 111 will be obtained, has an upper surface 12 and lower surface 14. The face stock 10 is placed into registration with the release stock 37, with the lower surface 14 of the face stock in contact with the adhesive coating 35. This four-layer assembly is referred to as a pressure sensitive label stock and is designated by the numeral 30 in FIG. 1.

The face stock 10 is severed along line 10′, as best seen in FIG. 1 to form individual labels 11, and such labels may be rectangular, as shown, or may be any other shape, round, oblong, trapezoidal, etc. An ultraviolet light curable second adhesive layer 33 is disposed, preferably printed onto the face stock 10 on its upper surface 12, as a Dyer peripheral to the severing line 10′ around each of the labels 11. The adhesive layer 33 is shown in FIG. 1 separated from the label stock 30. A donor ribbon strip, of paper or plastic film, is disposed in registry with the face stock 10, the donor ribbon strip 20 providing inclusively, a thermal transfer coating 21 which is placed in contact with the second adhesive 33. The transfer coating 21 is preferably of ink combined with either a wax, a wax and resin or resin all of which are thermally activated. The thermal transfer coating 21 has a surface tension greater than the surface tension of the second adhesive 33 so that when the donor ribbon strip 20 is peeled away from the pressure sensitive label stock 30, the entire second adhesive 33 that sounds the labels 111 is also removed.

The donor ribbon strip 20 is severed along line 20′ as best seen in FIG. 1. This severance in 20′ is exterior to severance line 10′ and enables portions of the donor ribbon 20 to remain in contact with the labels 11 when the remainder of the donor ribbon 20 is peeled off of the finished assembly. As described, the labels 11, defined by severance line 10′ are aligned longitudinally on the face stock 10 with each one of the labels 11 positioned within one of the donor ribbon strip portions defined by severance lines 20′. This is clearly shown in FIG. 1. The second adhesive 33 is peripheral to the labels 11 and extends to both sides of label stock 30 and also between labels 11.

The present invention is further defined as a method of preparing the above described self-contained thermal transfer label. This method comprises the steps of providing the release stock 37 as a strip of supportive material, coating the release stock 37 with the release coating 39; overcoating the release coating 39 with the first adhesive coating 35 registering or aligning the face stock 10 with the release stock 37 and overlaying the face stock 10 onto the adhesive coating 35. This 4-layer assembly is best seen at the bottom of FIG. 1. The method further comprises severing the face stock 10 at lines 10′ into a sequence of labels aligned longitudinally on the face stock 10, placing, by printing or other selective lay-down technique, the ultra violet light curable second adhesive 33, onto the face stock peripheral to the tables 11, which means on all surface areas of the face stock 10 other than the label 11 areas and then placing the donor ribbon strip 20 including its transfer coating 21 in registry with the face stock 10, and in contact with the second adhesive 33 so that it is fully engaged with the second adhesive 33, and finally severing the donor ribbon strip 20 along with the second adhesive 33, the face stock 10, and the first adhesive layer 35, peripheral to the tablet 11 and spaced apart from it, as is clearly shown in FIG. 1. Further steps in the present method include the steps of stripping off the portions of the donor ribbon strip 20 not covering the labels 11 and coiling or fan-folding the face stock 30 with the labels 11 and remaining portions of the donor ribbon strips 30 for later use in the direct thermal printers.

The present invention is further described in the following. It comprises a release stock 37, preferably a face stock, supporting a release coating 39 and, over the release coating, a first adhesive coating 35. A face stock 10, from which printed labels 11 will be obtained, has an upper surface 12 and a lower surface 14. The face stock 10 is placed into registration with the release stock 37, with the lower surface 14 of the face stock in contact with the adhesive coating 35. This four layer assembly is referred to as a pressure sensitive label stock and is designated by the numeral 30 in FIG. 1.

The face stock 10 is severed along line 10′, as best seen in FIG. 1 to form individual labels 11, and such labels may be rectangular, as shown, or may be any other shape, round, oblong, trapezoidal, etc. An ultraviolet light curable second adhesive layer 33 is disposed, preferably printed onto the face stock 10 on its upper surface 12, as a layer peripheral to the severing line 10′ around each of the labels 11. The adhesive layer 33 is shown in FIG. 1 separated from the label stock 30. A donor ribbon strip 20, of paper or plastic film, is disposed in registry with the face stock 10, the donor ribbon strip 20 providing, inclusively, a thermal transfer coating 21 which is placed in contact with the second adhesive 33. The transfer coating 21 is preferably comprised of a printing ink combined with either a wax, a resin or both wax and resin. The thermal transfer coating 21 has a surface tension greater than the surface tension of the second adhesive 33 so that when the donor ribbon strip 20 is peeled away from the pressure sensitive label stock 30 all of the second adhesive 33 that surrounds the labels 11 is also removed.

The donor ribbon strip 20 is severed along line 20′ as best seen in FIG. 1. This severance line 20′ is exterior to severance line 10′ and enables portions of the donor ribbon 20 to remain in contact with the labels 11 when the remainder of the donor ribbon 20 is peeled off of the finished assembly. As described, the labels 11, defined by severance lines 10′ are aligned longitudinally on the face stock 10 with each one of the labels 11 positioned within one of the donor ribbon strip portions defined by severance lines 20′. This is clearly shown in FIG. 1. The second adhesive 33 is peripheral to the labels 11 and extends to both sides of label stock 30 and also between the labels 11.

The present invention is further defined as a method of preparing the above described self-contained thermal transfer label. This method comprises the steps of providing the release stock 37 as a strip of supportive material; coating the release stock 37 with the release coating 39; overcoating the release coating 39 with the first adhesive coating 35; registering or aligning the face stock 10 with the release stock 37 and overlaying the face stock 10 onto the adhesive coating 35. This 4 layer assembly is best seen at the bottom in FIG. 1. The method further comprises severing the face stock 10 at lines 10′ into a sequence of labels aligned longitudinally on the face stock 10; placing, by printing or other selective lay-down technique, the ultra-violet light curable second adhesive 33 onto the face stock peripheral to the, labels 11, which means on all surface areas of the face stock 10 other than the label 11 areas and then placing the donor ribbon strip 20 including its transfer coating 21 in registry with the face stock 10, and in contact with the second adhesive 33 so that it is fully engaged with the second adhesive 33, and finally, severing the donor ribbon strip 20 along with the second adhesive 33, the face stock 10, and the first adhesive layer 35, peripheral to the label 11 and spaced apart from it, as is clearly shown in FIG. 1. Further steps in the present method include the step of thermally transferring a portion of the transfer coating 21 from the donor ribbon strip 20 to the front surface 12 of the labels 11, that is, printing the labels 11, and then stripping off the portions of the donor ribbon strip 20 not covering the labels 11; and finally, coiling the release stock 30 with the labels 11 and remaining portions of the donor ribbon strip 30 for later use in marking packages and similar applications.

The materials of construction and certain detailed information and techniques in making the present invention are fully detailed in my previous patent application (Parent Application) which is identified at the beginning of this specification and which is incorporated by reference herein.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A self-contained thermal transfer label apparatus comprising: a release stock supporting a release coating and, over the release coating, a first adhesive coating; a face stock having an upper surface and a lower surface, the face stock in registration with the release stock, with the lower surface of the face stock in adhesive contact with the adhesive coating, the face stock severed into labels aligned along the face stock; an ultraviolet light curable second adhesive disposed on portions of the upper surface of the face stock exterior to the labels; a donor ribbon strip disposed in registry with the face stock, the donor ribbon strip providing a thermal transfer coating in engaged contact with the second adhesive, the thermal transfer coating having a surface tension greater than a surface tension of the second adhesive; the donor ribbon strip severed exterior to the labels, enabling removal of portions of the donor ribbon strip while leaving further portions of the donor ribbon strip over the labels.

2. A self-contained thermal transfer label apparatus comprising: a release stock supporting a releasable face stock having an upper surface and a lower surface, the face stock severed into labels aligned along the face stock; an ultra-violet light curable adhesive disposed on portions of the upper surface of the face stock exterior to the labels; a donor ribbon strip disposed in registry with the face stock, the donor ribbon strip providing a thermal transfer coating engaged with the adhesive, the thermal transfer coating having a surface tension greater than a surface tension of the second adhesive; the donor ribbon strip severed exterior to the labels, enabling removal of portions of the donor ribbon strip while leaving further portions of the donor ribbon strip over the labels.

3. A method of preparing a self-contained thermal transfer label comprising the steps of: providing a release stock as a strip of supportive material; coating the release stock with a release coating; overcoating the release coating with a first adhesive coating; registering a face stock with the release stock and overlaying the face stock onto the adhesive coating; severing the face stock into a sequence of labels aligned longitudinally on the face stock; placing an ultra-violet light curable second adhesive onto the face stock peripheral to the labels; semi-curing the second adhesive using an ultra-violet light energy; placing a donor ribbon strip including a transfer coating in registry with the face stock, onto the second adhesive for attachment thereof; and together, severing the donor ribbon strip, second adhesive and face stock peripherally to the label and spaced apart from it.

4. The method of claim 3 further comprising the steps of thermally transferring a portion of the transfer coating from the donor ribbon strip to the front surface of the labels; stripping off portions of the donor ribbon strip not covering the labels; and coiling the release stock with the labels and remaining portions of the donor ribbon strip.
